(19) United States
(12) Patent Application Publication
(10) Pub. No.: US 2010/0180449 A1
(43) Pub. Date: Jul. 22, 2010

(54) AUTO FEED UTILITY KNIFE

(76) Inventor: Gary E. van DEURSEN, Essex, CT (US)

Correspondence Address: MCDERMOTT WILL & EMERY LLP, 600 13TH STREET, N.W., WASHINGTON, DC, 20005-3096, US

(21) Appl. No.: 12/688,360

(22) Filed: Jan. 15, 2010

Related U.S. Application Data
(60) Provisional application No. 61/193,995, filed on Jan. 16, 2009.

(51) Int. Cl. B26B 5/00; B26B 1/08

(52) U.S. Cl. 30/162; 30/337

(57) ABSTRACT

A utility knife having a knife body, a movable blade holder inside the knife body for slidably moving a flat blade and a blade retaining arm selectively engageable with the blade for removably retaining the flat blade on the blade holder, and a blade release button engageable with the blade retaining arm for disengaging the blade retaining arm from the blade. The blade release button is slidably mounted in the knife body and movable in a direction substantially parallel to a major plane of the flat blade such that sliding the blade release button moves the blade retaining arm to disengage the blade retaining arm from the blade.

### CROSS REFERENCE TO PROVISIONAL APPLICATION

This application is based upon and claims the benefit of priority from Provisional U.S. Patent Application 61/193,995 filed on Jan. 16, 2009, the entire contents of which are incorporated by reference herein.

### TECHNICAL FIELD

The present disclosure relates to utility knives. The present disclosure has particular applicability to retractable utility knives with replaceable blades.

### BACKGROUND

Utility knives are hand-held cutting tools capable of a wide range of uses. Some utility knives include a longitudinal main frame to house a snap-off blade, which has a series of fracture lines and can be broken transversely to expose a new sharp edge portion. However, one problem with knifes of this design is that breaking the snap-off blade to obtain a new, sharp blade can lead to injury.

Some conventional utility knifes have blades which are exchangeable with new blades. Extra blades can be stored in a compartment within the main frame of the utility knife. However, a number of utility knives have many movable parts which makes them difficult to use and expensive to manufacture. In some of these utility knives replacement of the blade is a complicated operation which may require the use of special tools or tedious dissembling and then reassembling of the utility knife to affect changing of the blade, which is inconvenient to the user.

### SUMMARY

To overcome the disadvantages discussed above, the present application is directed to a utility knife that allows for easy and safe changing of the blade.

One embodiment of the present disclosure is directed to a utility knife comprising a knife body, a movable blade holder inside the knife body for slidably moving a flat blade and having a blade retaining arm selectively engageable with the blade for removably retaining the flat blade on the blade holder, and a blade release device engageable with the blade retaining arm for disengaging the blade retaining arm from the blade. The blade release device is slidably mounted in the knife body and movable in a direction substantially parallel to a major plane of the flat blade such that sliding the blade release device moves the blade retaining arm to disengage the blade retaining arm from the blade.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a front perspective view of an auto-feed utility knife according to an embodiment of the present disclosure;

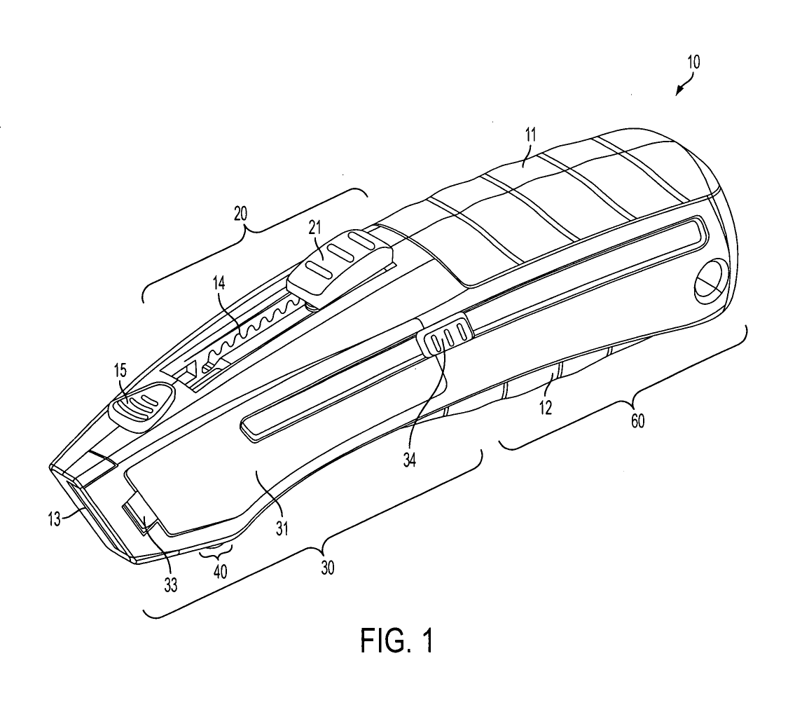

FIG. 2 is a front view of the knife according to FIG. 1;

FIG. 3 is a side view of the knife according to FIG. 1;

FIG. 4 is a top view of the knife according to FIG. 1;

FIG. 5 is a cutaway side view of the knife according to FIG. 1;

FIG. 6 is another cutaway side view of the knife according to FIG. 1;

FIG. 7 is a view of some of the internal components of the knife according to FIG. 1;

FIG. 8 is another cutaway side view of the knife according to FIG. 1;

FIG. 9 is another cutaway side view of the knife according to FIG. 1; and

FIG. 10 is a front perspective view of the knife according to FIG. 1 with its front feed door and blade storage compartment open.

### DETAILED DESCRIPTION

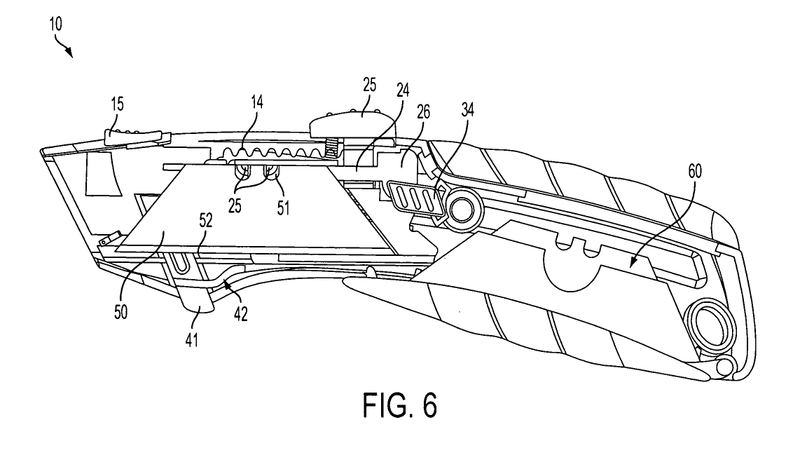

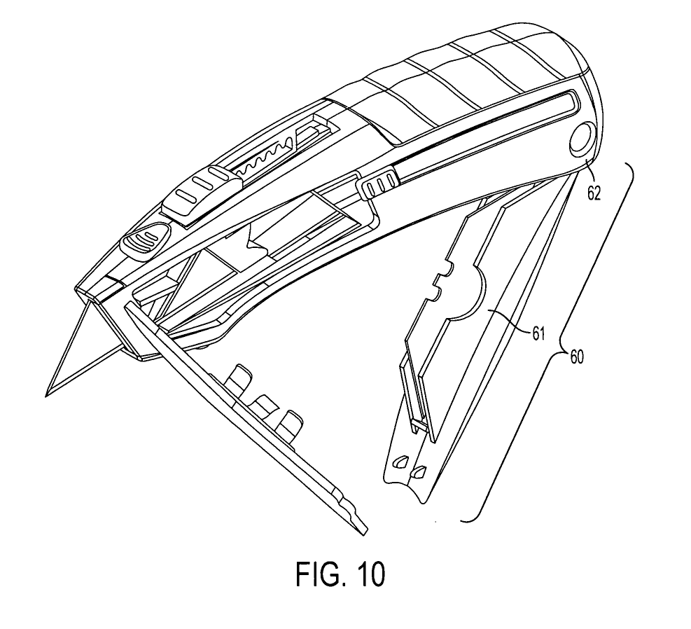

A utility knife of the present disclosure will now be described with reference to the drawings. The knife comprises a knife body 10, having a movable blade holder 20, a blade replacement compartment 30, and a blade release mechanism 40. The knife body 10 optionally comprises an upper grip 11 and a lower grip 12. One embodiment of the auto-feed utility knife of the present disclosure is adapted to use a standard utility knife blade 50 having a trapezoidal shape and a pair of notches 51 in its top edge opposite its sharpened edge 52 (as shown in FIG. 6). Some embodiments of the disclosed knife have a swing down blade storage compartment 60 in the lower bottom section of the handle (see FIG. 10). The blade replacement section 30 contains a door 31 which is openable with the door latch 34. The door 31 swings on a hinge 33 to open, allowing the user to insert blades 50 for storage and automatic replacement. This blade replacement section 30 feeds blades to the movable blade holder 20.

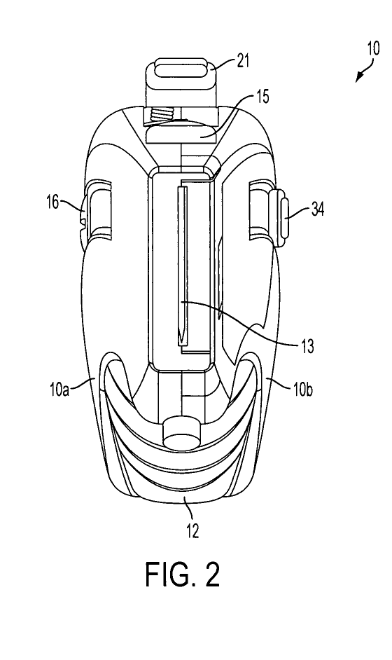

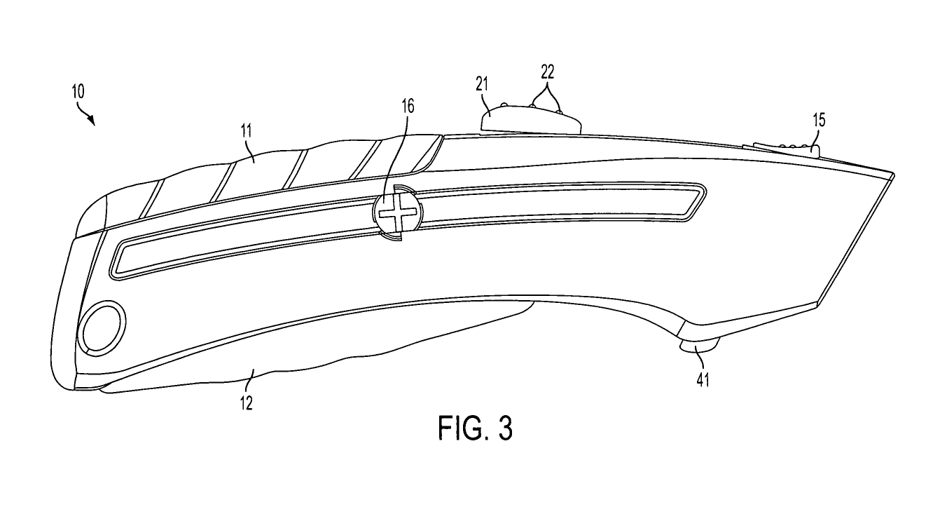

FIG. 2 is a front view of the utility knife, showing the blade opening portion 13 from which the blade 50 protrudes when in an extended position. FIG. 3 is a side view of the utility knife showing the side opposite from the blade replacement section 30. A screw 16 holds the knife body 10, comprised of two half sections 10a and 10b, together.

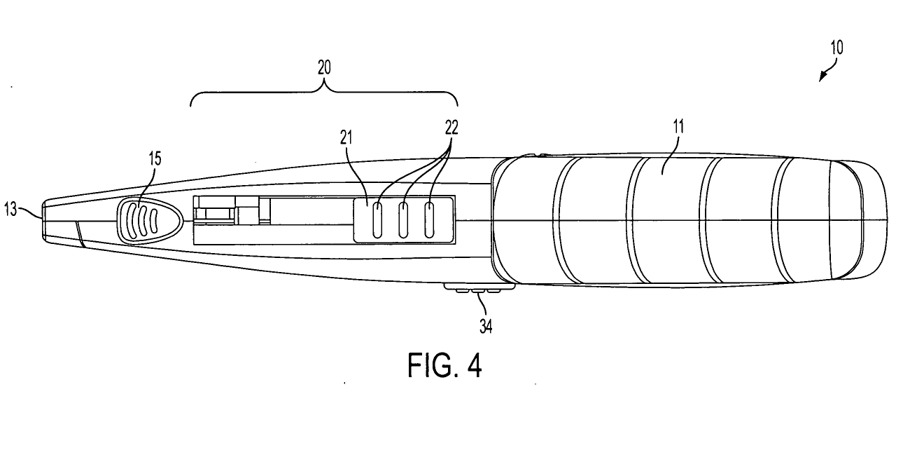

FIG. 4 is a top view of the utility knife, showing the blade slide button 21 of the movable blade holder 20. The blade slide button 21 slides along an opening in the knife body 10 so that the blade 50 may extend out from the opening 13. The slide button 21 has grip ribs 22 for better gripping. A finger guard 15 is located in a position forward along the sliding direction for a user to be aware of the blade opening 13 to prevent injury when the blade is in the extended position.

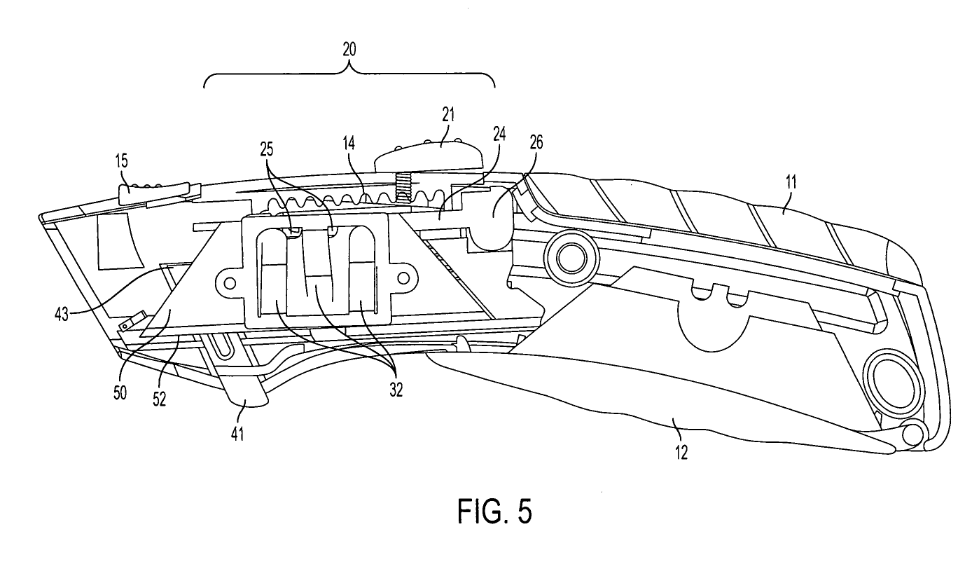

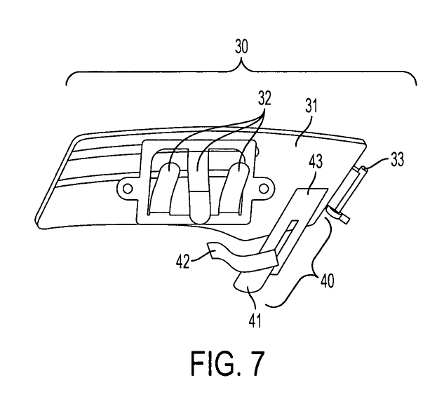

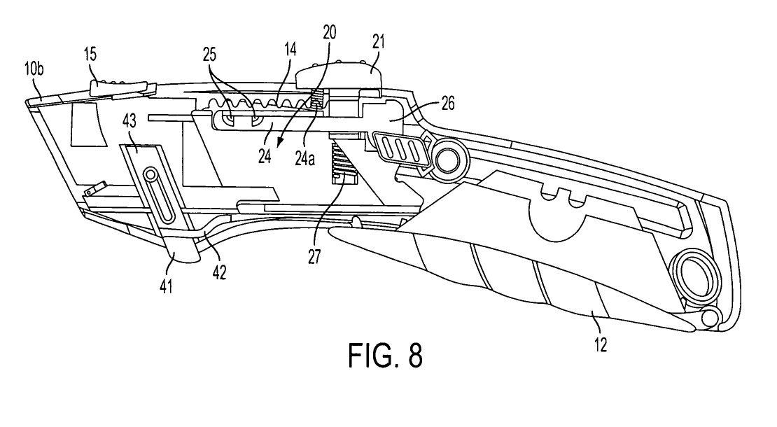

FIG. 5 shows the inside of the knife body 10 without the door 31. A spring 32 biases a blade 50 toward the movable blade holder 20. The blade 50 is engaged with the movable blade holder 20 via nubs 25 on a blade retaining arm 24 that align and engage with the notches 51 in the blade 50 as shown in FIG. 6. FIG. 7 is a rear internal view of the door 31 having the spring 32 attached to the inside thereof. The blade release mechanism 40 is shown in relation to the door. FIG. 8 is a view without the blade 50 to show the nubs 25. The blade retaining arm 24 is movably connected to the blade slide button 21. A spring 27 biases button 21 such that movable blade holder 20 is biased into engagement with a corresponding tooth 14 of blade body half section 10b. Upon pressing the blade slide button 21, the entire movable blade holder 20 slides in a linear direction along the length of the knife body 10, thereby allowing a blade 50 to extend from the blade opening 13 when a blade 50 is engaged with the blade retaining arm 24.

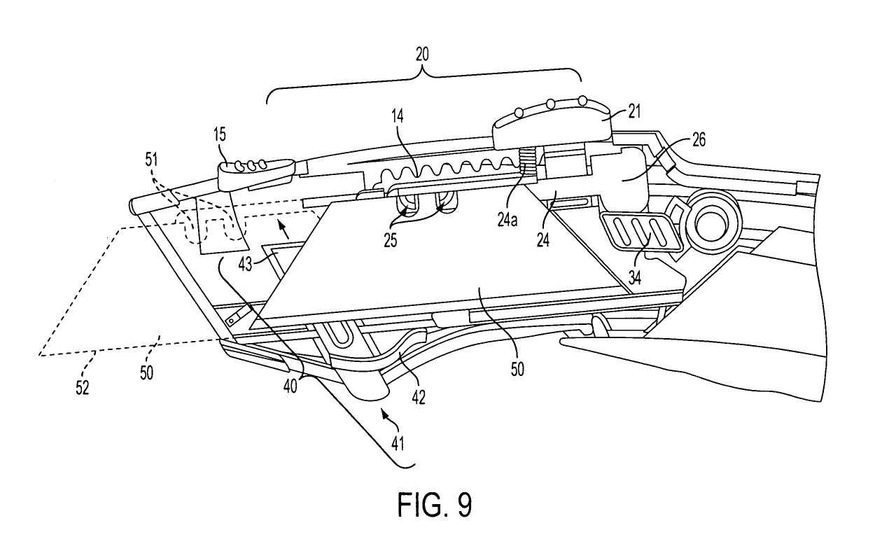

As shown in FIG. 9, a blade release button 41 and spring 42 are slidably mounted in the knife body 10 and movable in a direction substantially parallel to the major plane of blade 50, such that when the blade 50 is extended forward and the release button 41 is pushed upward (as indicated by an arrow), the terminal end 43 of the blade release mechanism 40 engages the blade retaining arm 24, pushing it upward. The blade retaining arm 24 rotates about a pivot point 26 located inside the knife body 10 in close proximity to the door latch 34, and is normally biased into engagement with blade 50 by a spring 24a. When retaining arm 24 is lifted by release mechanism 40, the nubs 25 of the blade retaining arm 24 consequently disengage from the blade notches 51, thereby allowing the blade 50 to be removed by sliding it out blade opening 13 in the front of the knife body 10. When the knife is in this state, a blade 50 can be inserted into the movable blade holder 20 by sliding it into blade opening 13, if desired. Alternatively, after removing blade 50, the blade release button 41 is released and the empty blade holder 20 is retracted to its rearmost position. The spring 32 on the door 31 (see FIG. 7) then pushes a fresh blade 50 into the movable blade holder 20.

FIG. 10 is a top perspective view of the utility knife of another embodiment of the present disclosure comprising a blade storage compartment 60. In this figure, the blade holder 61 is in an open position, showing a blade 50 in a cavity for holding additional blades. The blade holder pivots on a hinge 62 that may be opened and closed. The blade holder is held shut by a latch (not shown).

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A utility knife comprising:
a knife body;
a movable blade holder inside the knife body for slidably moving a flat blade and having a blade retainer selectively engageable with the blade for removably retaining the flat blade on the blade holder; and
a blade release button engageable with the blade retainer for disengaging the blade retainer from the blade,
wherein the blade release button is slidably mounted in the knife body and movable in a direction substantially parallel to a major plane of the flat blade such that sliding the blade release button moves the blade retainer to disengage the blade retainer from the blade.

2. The utility knife of claim 1, wherein the knife body comprises a blade replacement compartment in communication with the blade holder for storing an additional blade.

3. The utility knife of claim 2, wherein said blade replacement compartment comprises a door; and
a blade supply unit attached to the door,
wherein the blade supply unit is for supplying the additional blade to the blade holder upon removal of the blade.

4. The utility knife of claim 3, wherein the blade supply unit comprises at least one spring for biasing the additional blade toward the blade holder.

5. The utility knife of claim 1, wherein upon sliding the blade release button, a blade is insertable from outside the knife into the blade holder.

6. The utility knife of claim 1, wherein the blade release button is slidable in a direction toward a sharp edge of the blade.

7. The utility knife of claim 1, wherein the blade retainer comprises a blade retaining arm having a nub engageable with a notch in the blade to retain the blade on the blade holder, wherein the blade retaining arm is pivotally attached to the movable blade holder; wherein the blade retainer further comprises a spring for biasing the blade retaining arm nub into engagement with the blade notch; and
wherein the blade release button is slidable to pivot the blade retaining arm to move the nub out of engagement with the blade notch.

8. The utility knife of claim 1, wherein a free end of the blade release button projects from the knife body and a user can slide the blade release device by pushing the free end.

9. The utility knife of claim 1, further comprising a blade storage compartment in the handle of the knife body for storing an additional blade.

10. The utility knife of claim 7, wherein the movable blade holder is for moving the blade from a retracted position where the blade is completely within the knife body to an extended position wherein an end of the blade projects through an opening in an end of the knife body, and the blade release button engages and pivots the blade retaining arm when the blade is in the extended position such that the blade can be removed from the knife body by a user.
